(19) United States
(12) Patent Application Publication
(10) Pub. No.: US 2025/0353456 A1
(43) Pub. Date: Nov. 20, 2025

(54) VOICE CONTROL SYSTEM AND METHOD FOR CONTROLLING DOOR OF VEHICLE

(71) Applicants: Hyundai Motor Company, Seoul (KR); Kia Corporation, Seoul (KR)

(72) Inventors: Xu Qiang Sun, Shandong (CN); Zi Shuan Song, Shandong (CN); Hanghang Wang, Shandong (CN); Xi Zhen Hu, Shandong (CN)

(21) Appl. No.: 19/196,069

(22) Filed: May 1, 2025

(30) Foreign Application Priority Data
May 14, 2024 (CN) 202410598245.2

(51) Int. Cl. B60R 16/037

(52) U.S. Cl. CPC B60R 16/0373

(57) ABSTRACT

A voice control system includes a communication device, a voice receiving device, and a voice control device. The communication device is configured to, when a mobile device of a vehicle user enters a detection range of the communication device, detect a location of the mobile device by communicating with the mobile device and to detect whether the mobile device is authenticated, the voice receiving device is configured to receive voice information of the vehicle user, and the voice control device is configured to control the voice receiving device to receive the voice information from an outside of the vehicle based on whether the authenticated mobile device has entered the detection range, where voice information includes voice information for controlling a door such as a tailgate, a rear trunk lid, or a front trunk lid, and the received voice information is recognized to control a corresponding target vehicle-mounted device.

### CROSS-REFERENCE TO RELATED APPLICATION

This application claims under 35 U.S.C. § 119(a) the benefit of Chinese Patent Application No. 202410598245.2 filed with the Chinese Intellectual Property Office on May 14, 2025, the entire contents of which are incorporated herein by reference.

### BACKGROUND

### (a) Technical Field

The present disclosure relates to a voice control system and a voice control method for a vehicle, more particularly, to the voice control system and method for controlling a door such as a tailgate, a rear trunk lid, or a front trunk lid of the vehicle.

### (b) Description of the Related Art

A vehicle such as a car or SUV typically has several doors. Most doors are provided on sides of the vehicle for a passenger to enter or exit the vehicle. In addition, the doors may further include a front trunk lid, a rear trunk lid, or a tailgate. If the vehicle is a sedan-type passenger vehicle, the rear trunk lid is provided at the rear of the vehicle. If the vehicle is another type of vehicle, such as a sport utility vehicle (SUV), a recreational vehicle (RV), or a cargo vehicle, the tailgate is provided at the rear of the vehicle. The rear trunk lid or tailgate is intended to provide a wide and open loading space. In order to increase a loading space of a vehicle, in addition to the rear trunk lid or the tailgate provided at the rear of the vehicle, many vehicles (e.g., electric vehicles) are provided with a front trunk lid at the front.

For example, a tailgate that opens automatically is mounted in many vehicles. Accordingly, when a vehicle user with a smart key approaches the tailgate and reaches a certain distance from the tailgate, the tailgate automatically opens. However, when the vehicle user approaches the tailgate without intending to open the tailgate, the tailgate may be opened automatically. For example, if the vehicle user with the smart key washes the rear of the vehicle, stands at the rear of the vehicle to talk, or a child with the smart key plays at the rear of the vehicle, the tailgate may open unintentionally.

In addition, a hands-free vehicle tailgate system also exists. In a case of the hands-free vehicle tailgate system, when the vehicle user carries a load with both hands, the vehicle user has to lift his or her foot and kick within a detection range of a sensor located at a bottom inside a rear bumper. However, if a kicking posture of the vehicle user is not accurate, the tailgate may not be opened, or the vehicle user may fall over as he or she maintains the kicking posture for a long period of time.

The above information disclosed in this Background section is only for enhancement of understanding of the background of the invention and therefore it may contain information that does not form the prior art that is already known to a person of ordinary skill in the art.

### SUMMARY

The disclosure provides a voice control system and a voice control method for a vehicle. In particular, when a vehicle user carrying a mobile device approaches the vehicle, a tailgate, a rear trunk lid, or a front trunk lid may be opened by saying “open the tailgate”, “open the rear trunk lid”, or “open the front trunk lid.”

Accordingly, the inconvenience that the door is automatically opened when the vehicle user approaches the door even without intending to open the door or the inconvenience of operating the door with a kicking motion may be prevented.

According to an aspect of the present disclosure, a voice control system for a vehicle includes: a communication device configured to detect a location of a mobile device of a vehicle user by communicating with the detected mobile device and to detect whether the mobile device is authenticated; a voice receiving device configured to receive voice information of the vehicle user; and a voice control device configured to: receive the voice information from an outside of the vehicle when the authenticated mobile device has entered a detection range of the communication device, and recognize the voice information received from the voice receiving device; and control a target vehicle-mounted device according to the recognized voice information.

According to an exemplary embodiment, a voice control system for a vehicle is provided. The voice control system includes a communication device, a voice receiving device, and a voice control device.

The communication device may be configured to, when a mobile device carried by a vehicle user enters a detection range of the communication device, detect a location of the mobile device by communicating with the detected mobile device and to detect whether the mobile device is authenticated.

The voice receiving device may be configured to receive voice information of the vehicle user.

The voice control device may be configured to control the voice receiving device to receive the voice information from an outside of the vehicle based on whether the authenticated mobile device has entered the detection range of the communication device, wherein the voice information may include voice information for controlling a target vehicle-mounted device including at least a door and the door includes a tailgate, a rear trunk lid, or a front trunk lid, and the voice control device may be configured to recognize the voice information received from the voice receiving device and control the target vehicle-mounted device including the door corresponding to the recognized result.

The communication device may include a plurality of ultra-wideband (UWB) sub-devices or a plurality of Bluetooth low energy (BLE) sub-devices and a UWB BLE master device, the plurality of UWB sub-devices or the plurality of BLE sub-devices may be provided at a plurality of locations of the vehicle, the plurality of UWB sub-devices or the plurality of BLE sub-devices, each may be configured to transmit a request signal, wherein the request signal forms a detection region outside the vehicle, and may be configured to receive a response signal transmitted in response to the request signal when the mobile device enters the detection region, and the UWB BLE master device may be configured to detect the location of the mobile device based on the response signal from the mobile device and the request signal from at least one of the plurality of UWB sub-devices or the plurality of BLE sub-devices.

The UWB BLE master device may be further configured to compare verification information of the mobile device included in the response signal from the mobile device with pre-stored verification information and detect that the mobile device is authenticated when the verification information of the mobile device matches one of the pre-stored verification information.

The voice control device may be further configured to receive the location of the mobile device from the communication device and adjust a door opening height according to a height of the mobile device.

The voice control device may be configured to receive the verification information of the mobile device from the communication device and open the door to a height matching the verification information of the mobile device.

The voice control system may further include: an input device configured to obtain a correspondence relationship between the verification information of the mobile device and the door opening height preset by the vehicle user, wherein the voice control device may be further configured to open the door to the height matching the verification information of the mobile device based on the correspondence relationship between the verification information of the mobile device received from the input device and the door opening height.

The door opening height may be within a range of 30 cm to 160 cm.

The voice information may include voice information for controlling a seat, a headlamp, a back lamp, a window, or a sunroof, and the target vehicle-mounted device may include the seat, the headlamp, the back lamp, the window, or the sunroof.

The voice control system may further include: a voice output device, wherein the voice control device is configured to control the voice output device to output a control result of the target vehicle-mounted device to the vehicle user.

The voice receiving device may be a microphone, and the microphone may be provided on each of outside rearview mirrors on left and right sides of the vehicle, the tailgate or the rear trunk lid, or inside the mobile device.

A vehicle may include the above-described voice control system.

According to another aspect of the present disclosure, a voice control method for a vehicle includes: detecting, by a communication device, whether a mobile device of a vehicle user has entered a detection range of the communication device; detecting, by the communication device, a location of the mobile device when the mobile device of the vehicle user has entered the detection range of the communication device; detecting, by the communication device, whether the mobile device is authenticated; operating, by a voice control device, a voice receiving device in response to detecting that the authenticated mobile device has entered the detection range of the communication device; receiving, by the voice receiving device, voice information of the vehicle user; recognizing, by the voice control device, the voice information received from the voice receiving device; and controlling, by the voice control device, a target vehicle-mounted device according to the recognized voice information

According to another exemplary embodiment provides a voice control method for a vehicle.

The voice control method includes: detecting whether a mobile device carried by a vehicle user has entered a detection range of a communication device by the communication device; detecting a location of the mobile device by the communication device based on whether the mobile device carried by the vehicle user has entered the detection range of the communication device; detecting whether the mobile device is authenticated by the communication device; controlling a voice receiving device to operate by a voice control device in response to detecting that the authenticated mobile device has entered the detection range of the communication device; receiving voice information of the vehicle user by the voice receiving device, wherein the voice information includes voice information for controlling a target vehicle-mounted device including at least a door, and the door includes a tailgate, a rear trunk lid, or a front trunk lid; recognizing the voice information received from the voice receiving device by the voice control device; and controlling the target vehicle-mounted device including the door corresponding to a recognized result by the voice control device.

The detecting a location of the mobile device may include: transmitting a request signal by at least one of a plurality of UWB sub-devices or a plurality of BLE sub-devices installed at a plurality of locations of the vehicle, wherein the request signal forms a detection region outside the vehicle; receiving a response signal transmitted from the mobile device in response to the request signal by the at least one of the plurality of UWB sub-devices or the plurality of BLE sub-devices when the mobile device enters the detection region; and detecting the location of the mobile device based on the response signal from the mobile device and the request signal from the at least one of the plurality of UWB sub-devices or the plurality of BLE sub-devices by a UWB BLE master device.

The detecting whether the mobile device is authenticated may include: comparing verification information of the mobile device included in the response signal of the mobile device with pre-stored verification information by the UWB BLE master device; and detecting that the mobile device is authenticated by the UWB BLE master device when the verification information of the mobile device matches one of the pre-stored verification information.

The controlling the door may include: receiving, by the voice control device, the location of the mobile device from the communication device; and adjusting, by the voice control device, a door opening height according to a height of the mobile device.

The controlling the door may include: receiving, by the voice control device, the verification information of the mobile device from the communication device; and opening, by the voice control device, the door to a height matching the verification information of the mobile device.

The opening the door to a height matching the verification information of the mobile device may include: obtaining, by an input device, a correspondence relationship between the verification information of the mobile device and the door opening height previously set by the vehicle user; and opening by the voice control device, the door to the height matching the verification information of the mobile device based on the correspondence relationship between the verification information of the mobile device received from the input device and the door opening height.

The voice information may include voice information for controlling a seat, a headlamp, a back lamp, a window, or a sunroof; and the target vehicle-mounted device may include the seat, the headlamp, the back lamp, the window, or the sunroof.

The voice control method may further include: controlling, by the voice control device, a voice output device to output a control result of the target vehicle-mounted device to the vehicle user.

The disclosure adopts the above technical solution and has the following beneficial effects.

When the vehicle user carrying the mobile device approaches the vehicle, the tailgate, the rear trunk lid, or the front trunk lid may be opened by saying “open the tailgate”, “open the rear trunk lid”, or “open the front trunk lid.”

Accordingly, the inconvenience that the door is automatically opened when the vehicle user approaches the door even without intending to open the door or the inconvenience of operating the door with the kicking motion may be prevented.

In addition, an intelligence of the vehicle may be increased by adding human-computer interaction through a voice control.

In addition, the tailgate, the rear trunk lid, or the front trunk lid may be conveniently used by the vehicle user by automatically adjusting the opening height according to the height of the vehicle user.

In addition, the driver may also control the seat, the headlamp, and/or the back lamp through the voice.

In addition, the effects that may be obtained or expected due to the exemplary embodiments of the disclosure are disclosed directly or implicitly in the detailed description of the exemplary embodiments of the disclosure. That is, the various effects expected according to the exemplary embodiments of the disclosure are disclosed in the detailed description to be described below.

### BRIEF DESCRIPTION OF THE DRAWINGS

Hereinafter, exemplary embodiments of the disclosure are described in detail by referring the accompanying drawings. For clarity, the same components across the different drawings are denoted by the same reference numerals. It should be noted that the drawings are only examples and are not necessarily drawn to scale.

FIG. 1 is a block diagram of a voice control system according to an exemplary embodiment of the disclosure.

FIG. 2 is a schematic diagram illustrating microphones provided in outside rearview mirrors on the left and right sides of a vehicle.

FIG. 3 is a schematic diagram illustrating a location of a microphone provided in a tailgate of a vehicle.

FIG. 4 is a schematic diagram of a communication device according to an exemplary embodiment of the disclosure.

FIG. 5 is a schematic diagram illustrating locations of a plurality of ultra-wideband (UWB) sub-devices.

FIG. 6 is a block diagram illustrating a detailed configuration of a voice control system for a vehicle according to an exemplary embodiment of the disclosure.

FIG. 7A is a schematic diagram illustrating a state when a vehicle user wants to open a front trunk lid.

FIG. 7B is a schematic diagram illustrating a state when a vehicle user wants to open a tailgate or a rear trunk lid of a vehicle.

FIG. 8 is a schematic diagram illustrating a state in which a tailgate is opened according to a height of a detected mobile device.

FIGS. 9A and 9B are schematic diagrams of a setting interface for adjusting an opening height of a tailgate according to an exemplary embodiment of the disclosure.

FIG. 10 is a flowchart of a voice control method for a vehicle according to an exemplary embodiment of the disclosure.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the disclosure are described in detail, and the exemplary embodiments are implemented based on the technical solution of the disclosure, and detailed implementation methods and specific operation processes are presented, but the scope of the disclosure is not limited to the following exemplary embodiments.

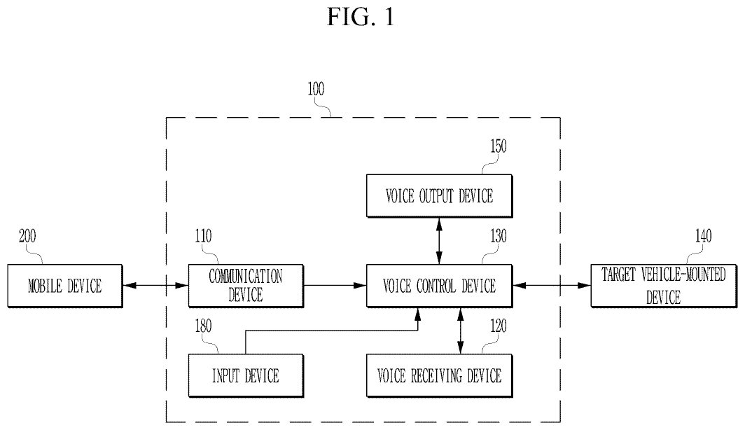

FIG. 1 is a block diagram of a voice control system according to an exemplary embodiment of the disclosure. As shown in FIG. 1, a voice control system 100 for a vehicle according to an exemplary embodiment of the disclosure includes a communication device 110, a voice receiving device 120, and a voice control device 130. When a mobile device 200 carried by a vehicle user enters a detection range of the communication device 110, the communication device 110 is configured to communicate with the detected mobile device 200 to detect a location of the mobile device 200 and to detect whether the mobile device 200 is authenticated. The voice receiving device 120 is configured to receive voice information of the user. In response to detecting that the authenticated mobile device 200 has entered the detection range of the communication device 110, the voice control device 130 may control the voice receiving device 120 to receive the voice information from outside the vehicle, and the voice information includes at least voice information for controlling a door. The voice control device 130 is configured to recognize the voice information received from the voice receiving device 120 and control a target vehicle-mounted device 140 including the corresponding door according to a recognition result. The door may include a tailgate, a rear trunk lid, or a front trunk lid.

Therefore, when the vehicle user carrying the mobile device (200, for example, a smart key) approaches the vehicle (specifically, enters the detection range), the tailgate, the rear trunk lid, or the front trunk lid may be opened by saying “open the tailgate”, “open the rear trunk lid”, or “open the front trunk lid.”

Accordingly, the inconvenience that the door is automatically opened when the vehicle user approaches the door even without intending to open the door or the inconvenience of operating the door with a kicking motion may be prevented.

Specifically, the voice receiving device 120 may be a microphone 121.

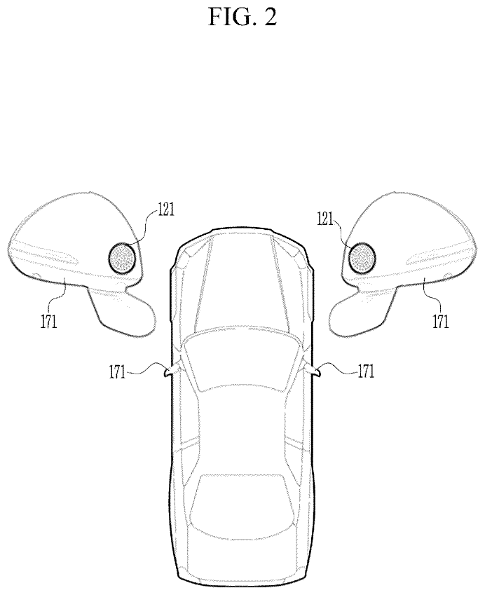

The microphone 121 may be provided in at least one of outside rearview mirrors 171 on the left and right sides of the vehicle. FIG. 2 is a schematic diagram illustrating microphones provided in the outside rearview mirrors on the left and right sides of the vehicle. The location of the vehicle outside rearview mirror 171 protruding from the outline of the vehicle may ensure that the microphone 121 properly receives voice from the outside the vehicle and is particularly suitable for voice reception when the vehicle user intends to control the front trunk lid.

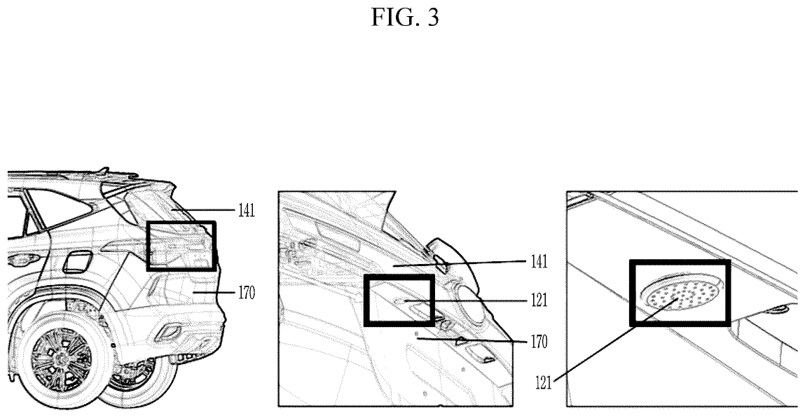

The microphone 121 may also be provided on the tailgate or the rear trunk lid. FIG. 3 is a schematic diagram illustrating a location of the microphone provided on the tailgate of the vehicle. As shown in FIG. 3, the microphone 121 may be provided in a frame portion of the tailgate 141. When the tailgate 141 is completely closed, the microphone 121 may be hidden between the tailgate 141 and a vehicle body 170 and may not be affected by weather conditions. The microphone 121 is suitable for voice reception when the vehicle user wants to control the tailgate 141 or the rear trunk lid at the location of the tailgate 141 or the rear trunk.

In addition, the microphone 121 may be the microphone 121 provided inside the mobile device.

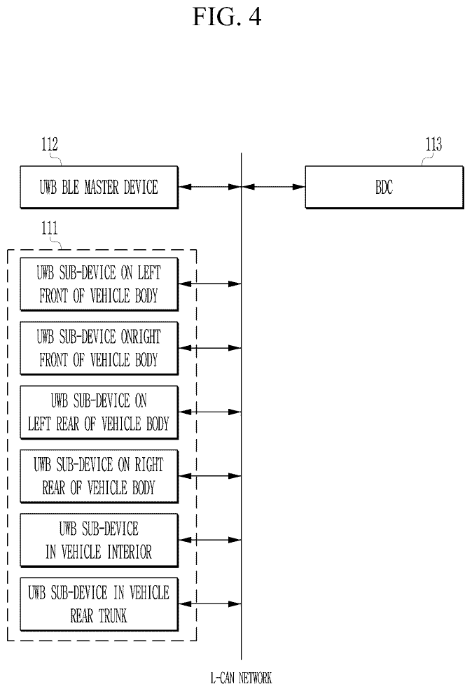

FIG. 4 is a schematic diagram of the communication device according to an exemplary embodiment of the disclosure. As illustrated in FIG. 4, the communication device 110 may include a plurality of ultra-wideband (UWB) sub-devices 111, a UWB Bluetooth low energy (BLE) master device 112, and a body domain controller (BDC) 113. The respective UWB sub-devices 111 located at four corners of the vehicle, inside the vehicle, and at the vehicle rear trunk and the UWB BLE master device 112 communicate with the BDC 113 via a local controller area network (L-CAN), and each UWB sub-device 111 may communicate with the UWB BLE master device 112 via the L-CAN of the vehicle. The UWB sub-devices 111 and the UWB BLE master device 112 each communicate with the mobile device 200.

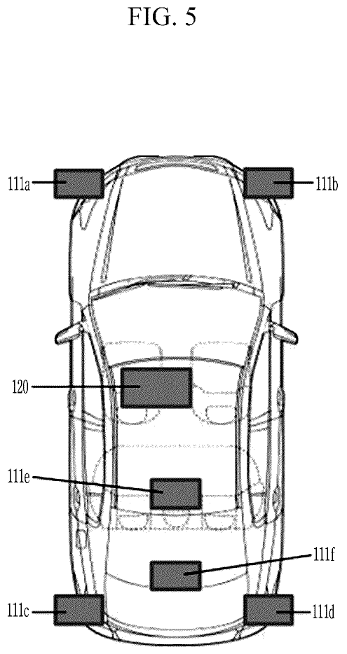

FIG. 5 is a schematic diagram illustrating locations of the plurality of UWB sub-devices. As illustrated in FIG. 5, the plurality of UWB sub-devices 111 are provided at a plurality of locations of the vehicle. Specifically, the plurality of UWB sub-devices 111 may include at least a first UWB sub-device 111a to a sixth UWB sub-device 111f. The first UWB sub-device 111a is provided at a left front of the vehicle body, the second UWB sub-device 111b is provided at a right front of the vehicle body, the third UWB sub-device 111c is provided at a left rear of the vehicle body, the fourth UWB sub-device 111d is provided at a right rear of the vehicle body, the fifth UWB sub-device 111e is provided inside the vehicle (specifically, an upper portion corresponding to a rear seat on a roof on a vehicle center axis), and the sixth UWB sub-device 111f is provided in the vehicle rear trunk (specifically, the rear trunk on the vehicle center axis).

The BDC 113 transmits a transmission request signal to the UWB sub-device 111, and when the UWB sub-device 111 receives the transmission request signal from the BDC 113, the UWB sub-device 111 may transmit the request signal. Each of the first UWB sub-device 111a to the sixth UWB sub-device 111f may transmit the request signal. That is, the request signal may be transmitted from the corresponding UWB sub-device 111. The request signal forms a detection region with a predetermined distance as a transmission radius, and the formed detection region may cover the outside of the vehicle within a predetermined range.

When the mobile device 200 (e.g., a smartphone) enters the detection region formed by the request signal, the mobile device 200 may transmit a response signal in response to the request signal. The UWB sub-device 111 may receive the response signal from the mobile device 200.

The UWB BLE master device 112 first performs positioning via BLE when the mobile device 200 is far from the vehicle, and then performs accurate positioning via UWB when the mobile device 200 approaches the vehicle. While the UWB BLE master device 112 performs the accurate positioning via the UWB, the UWB BLE master device 112 may detect the location of the mobile device 200 based on the response signal of the mobile device 200 and the request signal of the UWB sub-device 111.

Specifically, the UWB sub-device 111 transmits the response signal received from the mobile device 200 to the UWB BLE master device 112. The UWB sub-device 111 may transmit the request signal at predetermined time intervals, and the UWB BLE master device 112 may receive the response signal of each UWB sub-device 111, and accordingly, the UWB BLE master device 112 may determine a point in time at which the response signal is provided. Accordingly, the UWB BLE master device 112 may measure a time delay between the request signal and the response signal. The plurality of UWB sub-devices 111 is spatially distributed and all communicate with the mobile device 200. Accordingly, the UWB BLE master device 112 may calculate the accurate location of the mobile device 200 by using, for example a triangulation method, by measuring a difference in the time delays between the mobile device 200 and the respective UWB sub-devices 111. However, the disclosure is not limited thereto, and the UWB BLE master device 112 may accurately calculate the location of the mobile device 200 through other UWB positioning calculation methods.

In addition, the disclosure is not limited to the use of the UWB sub-device 111 and the UWB BLE master device 112, and the UWB sub-device 111 may be replaced with a BLE sub-device.

Currently, a positioning method based on low frequency or radio frequency (RF) may only detect a region in which the mobile device 200 is located, and may not accurately detect the location of the mobile device 200. However, a positioning method based on the UWB according to an exemplary embodiment of the disclosure may accurately detect the location of the mobile device 200.

In addition, the response signal of the mobile device 200 includes verification information of the mobile device 200, and the UWB BLE master device 112 may compare the verification information of the mobile device 200 with pre-stored verification information. If the verification information in the response signal of the mobile device 200 matches one of the pre-stored verification information, the UWB BLE master device 112 may detect that the mobile device is authenticated.

The UWB BLE master device 112 transmits a detection result (including the location of the mobile device 200 and the authentication of the mobile device 200) to the BDC 113. After receiving the detection result, the BDC 113 may transmit a wake-up command to the voice control device 130.

Specifically, the voice control device 130 may be implemented through an audio, video, navigation, and telematics (audio video navigation telematics (AVNT).

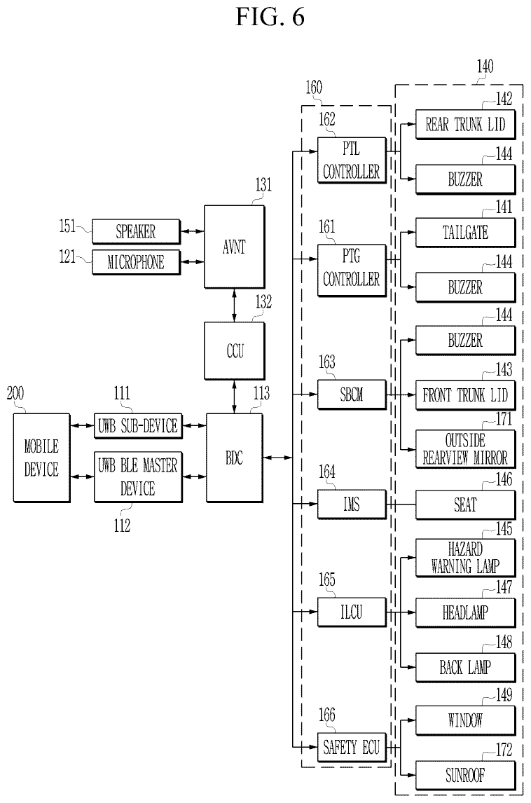

FIG. 6 is a block diagram illustrating a detailed configuration of a voice control system for the vehicle according to an exemplary embodiment of the disclosure. As shown in FIG. 6, the AVNT 131 receives the wake-up command from the BDC 113 and then controls the microphone 121 installed outside the vehicle to operate, thereby receiving the voice information of the user.

As described above, the microphone 121 may be located at the left and right outside rearview mirrors, and the microphone 121 may be suitable for voice reception when the vehicle user wants to control the front trunk at one of these locations. The microphone 121 may be positioned at the tailgate 141 or the rear trunk lid, and the microphone 121 may be suitable for voice reception when the vehicle user wants to control the tailgate 141 or the rear trunk lid at this location. Therefore, preferably, in the process in which the AVNT 131 controls the operation of the microphone 121, the AVNT 131 may activate the microphone 121 at the corresponding location according to the location of the mobile device detected by the UWB BLE master device 112. That is, when the mobile device is located at the rear of the vehicle, only the microphone 121 installed at the tailgate 141 or the rear trunk lid operates, and when the mobile device is located at the front or the side of the vehicle, only the microphone 121 installed at the left/right outside rearview mirrors operates. Therefore, noise inflow and voice recognition error delay, etc. that may arise when all microphones 121 at all locations are in an operating state may be prevented.

During the operation of the microphone 121 installed in the outside rearview mirrors on the left and right sides, the BDC 113 controls the outside rearview mirrors 171 on the left and right sides of the vehicle to unfold through a side body control module (SBCM) 163, thereby informing the vehicle user that the microphone 121 is receiving the voice information from the outside the vehicle.

When the vehicle user sends the voice information, the microphone 121 may receive the voice information and transmit the voice information to the AVNT 131. The AVNT 131 recognizes the voice information received from the microphone 121 and controls the corresponding target vehicle-mounted device 140 according to the recognized result. Specifically, the AVNT 131 may transmit a control command to the BDC 113. Since the BDC 113 acts as a master controller, the BDC 113 may process the control command received from the AVNT 131 and then send the control command to a control unit 160 of the target vehicle-mounted device 140. The control unit 160 controls the target vehicle-mounted device 140 according to the received control command.

If the microphone 121 is the microphone 121 installed inside the mobile device, the voice control device 130 may be realized through the mobile device and the AVNT 131. The mobile device may recognize the received voice information and obtain a recognized result. The AVNT 131 may establish a connection with the mobile device after receiving the wake-up command of the BDC 113. Therefore, the mobile device may send the recognized result to the AVNT 131, and the AVNT 131 controls the corresponding target vehicle-mounted device 140 according to the recognized result.

Specifically, the AVNT 131 may send the control command to the BDC 113, and the BDC 113 acts as the master controller. After processing the control command received from the AVNT 131, the BDC 113 sends the control command to the control unit 160 of the target vehicle-mounted device 140, and the control unit 160 controls the target vehicle-mounted device 140 according to the received control command.

Specifically, the voice information may include voice information for controlling the door, and correspondingly, the target vehicle-mounted device 140 may include the door. Since the door may include the tailgate 141, the rear trunk lid 142, or the front trunk lid 143, the control unit 160 may include a power tailgate (PTG) controller 161 for controlling the tailgate 141, a power trunk lid (PTL) controller 162 for controlling the rear trunk lid 142, and an SBCM 163 for controlling the front trunk lid 143.

The AVNT 131 and the BDC 113 may communicate using a communication control unit (CCU) 132, and the BDC 113 and each control unit 160 may communicate with each other.

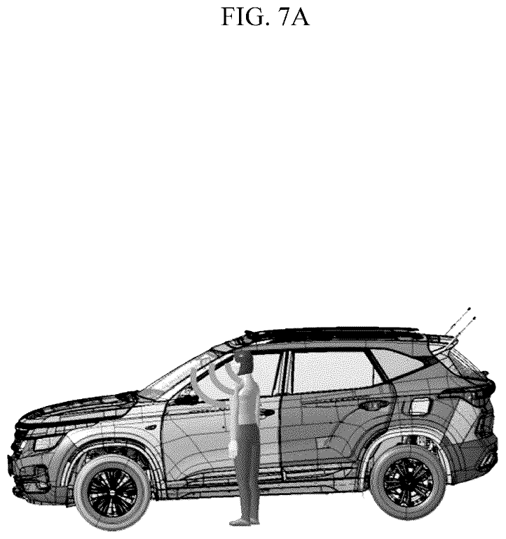

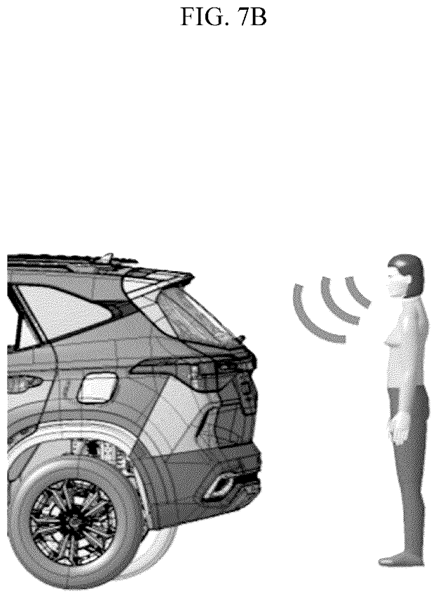

FIG. 7A is a schematic diagram illustrating a state when the vehicle user wants to open the front trunk lid. The vehicle user may approach the vehicle while holding the smart key. For example, as illustrated in FIG. 7A, the vehicle user may be positioned at the side of the vehicle. The location of the vehicle user is within a voice reception range of the microphone 121 installed in the outside rearview mirrors 171 on the left and right sides of the vehicle and also within the detection range of the communication device 110. At this time, the AVNT 131 may control the microphone 121 to operate. When the vehicle user says “open the front trunk lid,” the microphone 121 installed in the outside rearview mirrors 171 on the left and right sides of the vehicle may receive the voice information saying “open the front trunk lid” and transmit the voice information to the AVNT 131, and the AVNT 131 may recognize the voice information received from the microphone 121. Specifically, the AVNT 131 may recognize a target type that the vehicle user wants to set, for example, the “front trunk lid,” and an operation way of the target type, for example, “open.”

Accordingly, the AVNT 131 may control the SBCM 163 to operate through the BDC 113 according to the recognized result to open the front trunk lid 143.

FIG. 7B is a schematic diagram illustrating a state when the vehicle user wants to open the vehicle tailgate or the rear trunk lid. For example, the user of the vehicle equipped with the tailgate 141 may approach the vehicle while carrying the smart key. For example, as illustrated in FIG. 7B, the vehicle user may approach the vehicle tailgate 141 while positioned at the rear of the vehicle. The location of the vehicle user is within the voice reception range of the microphone 121 installed in the tailgate 141 and also within the detection range of the communication device 110. At this time, the AVNT 131 may control the microphone 121 to operate. When the vehicle user says “open the tailgate,” the microphone 121 installed in the tailgate 141 may receive the voice information of “open the tailgate” and transmit the voice information to the AVNT 131. The AVNT 131 may recognize the voice information received from the microphone 121. Specifically, the AVNT 131 may recognize the target type that the vehicle user wants to set, for example, the “tailgate,” and the operation way of the target type, for example, “open”. Accordingly, the AVNT 131 may control the PTG controller 161 to operate through the BDC 113 according to the recognized result, thereby opening the tailgate 141.

Referring back to FIG. 1, according to an exemplary embodiment of the disclosure, the voice control system 100 for the vehicle may further include a voice output device 150. The voice control device 130 may control the voice output device 150 to output a control result of the target vehicle-mounted device 140 to the vehicle user. Accordingly, the vehicle user may know whether the control of the target vehicle-mounted device 140 is completed through feedback in the form of voice. In addition, an exemplary embodiment of the disclosure increases an intelligence of the vehicle through a form of human-computer interaction. The voice output device 150 may be a speaker 151. The speaker 151 may be integrated with the microphone 121. For example, the PTG controller 161 may transmit the control result of the tailgate 141 to the AVNT 131 through the BDC 113, and the AVNT 131 may control the speaker 151 to output the voice, such as “the tailgate is opened.”

In addition, while the door (specifically, the tailgate 141, the rear trunk lid 142, or the front trunk lid 143) is being opened, a buzzer 144 may sound together with flashing of a hazard warning lamp 145, thereby informing the vehicle user that the corresponding door is being opened. Specifically, the PTG controller 161 or the PTL controller 162 may control the buzzer 144 to sound, and the BDC 113 may send the control command to an integrated lamp control unit (ILCU) 165, so that the ILCU 165 may control the flashing of the hazard warning lamp 145.

Currently, the tailgate 141, the rear trunk lid 142, or the front trunk lid 143 cannot automatically control an opening height according to a height of the vehicle user. When the vehicle user carries a load with both hands, if the door opening height is too high or too low, it may cause inconvenience to the vehicle user.

To solve the above problem, in an exemplary embodiment, the communication device 110 (specifically, the UWB BLE master device 112) may detect the location of the mobile device 200, so that the communication device 110 may detect the height of the mobile device 200 (belonging to height information at the location of the mobile device 200). When the vehicle user carries the load with both hands, the mobile device 200 (e.g., the smart key and the cell phone) is generally put in a pocket, so the height of the mobile device 200 may reflect a height of the vehicle user. The voice control device 130 may receive the height of the mobile device 200 from the communication device 110. When the voice control device 130 controls the opening of the tailgate 141 according to the recognized result, the voice control device 130 may adjust the height at which the tailgate 141 is opened according to the height of the mobile device 200. Therefore, the height at which the tailgate 141 is opened may be automatically adjusted according to the height of the detected mobile device 200 (i.e., the height of the vehicle user).

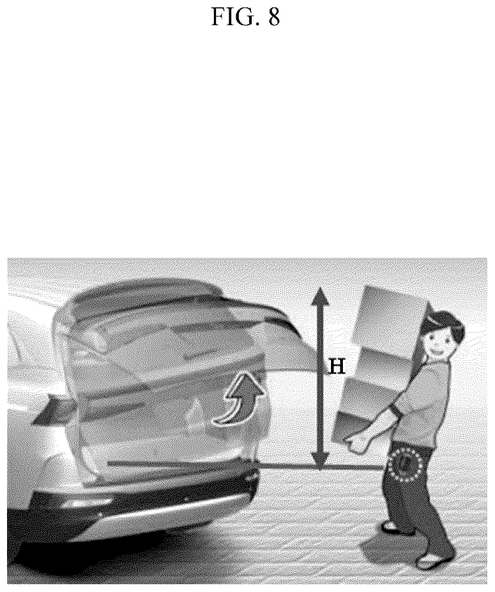

FIG. 8 is a schematic diagram illustrating a state in which the tailgate is opened according to the height of the detected mobile device. For example, the height H at which the tailgate 141 is opened according to the height of the mobile device 200 illustrated in FIG. 8 may be 90 cm. If the height of the mobile device 200 is higher or lower, the height at which the tailgate 141 is opened may be adjusted, for example, within a range of 30 cm to 160 cm.

In another exemplary embodiment, as described above, the communication device 110 (specifically, the UWB BLE master device 112) compares the verification information of the mobile device 200 with the pre-stored verification information to detect whether the verification information in the response signal of the mobile device 200 corresponds to any of the pre-stored verification information. The verification information of the mobile device 200 may include identification information (ID) of the vehicle user. Accordingly, the voice control device 130 may receive the verification information of the mobile device 200 from the communication device 110, and when the voice control device 130 opens the tailgate 141 according to the recognized result, the voice control device 130 may cause the tailgate 141 to be opened at the height of the user that matches the verification information. Accordingly, the problem that the height at which the tailgate 141 was opened according to the height of the vehicle user was not automatically adjusted may be solved even though the physiques (i.e., heights) of different vehicle users are different.

Specifically, referring back to FIG. 1, the voice control device 100 for the vehicle according to an exemplary embodiment of the disclosure may include an input device 180. The input device 180 is configured to obtain a correspondence relationship between the verification information of the mobile device 200 and the height at which the tailgate 141 is opened, which is previously set by the vehicle user.

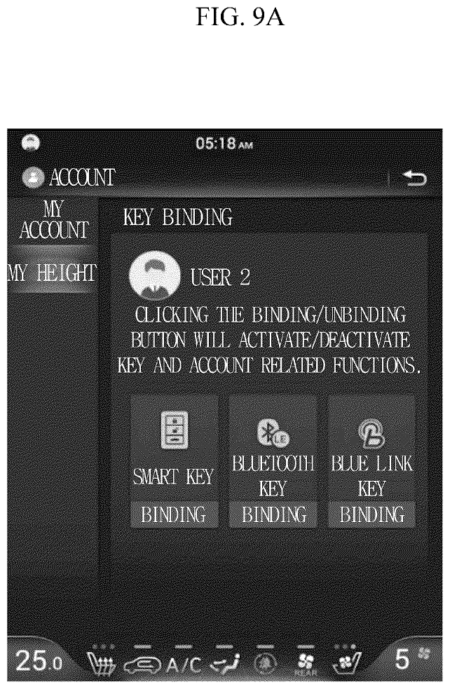

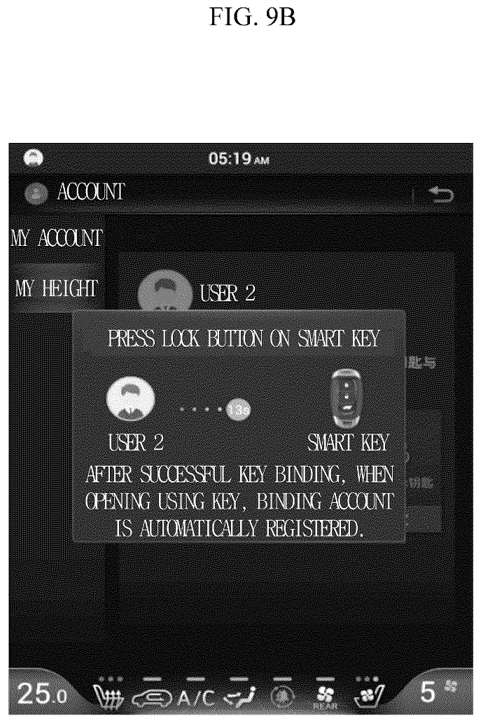

The input device 180 may be implemented as a touch screen integrated with a vehicle display terminal, and the vehicle display terminal may be configured to have a setting interface. FIGS. 9A and 9B are schematic diagrams of the setting interface for adjusting the opening height of the tailgate according to an exemplary embodiment of the disclosure. As illustrated in FIG. 9A, the vehicle user may create a user account, such as User 2, and may select and bind one of the smart key, a Bluetooth key, and a Blue Link key. As illustrated in FIG. 9B, the vehicle user may press a lock button of the smart key to bind User 2 and the smart key. At this time, the verification information of the smart key is stored in the communication device 110 (specifically, the UWB BLE master device 112). When the vehicle user carries the smart key and enters the detection range of the communication device 110, the communication device 110 may determine that the smart key is authenticated and that the identity of the vehicle user is User 2.

Thereafter, the vehicle user may set the height at which the tailgate 144 is opened in the corresponding user account. For example, the height at which the tailgate opens is set to 65 cm for user 1, and the height at which the tailgate opens is set to 60 cm for user 2. The height at which the tailgate 141 is opened may be set within a range of 30 cm to 160 cm. Through this, the vehicle user completes to set the correspondence relationship between the verification information of the mobile device 200 and the height at which the tailgate 141 is opened.

Specifically, the setting interface may be implemented through a user settings menu (USM) of the AVNT 131.

Similarly, the exemplary embodiment for automatically adjusting the tailgate 141 according to the height of the vehicle user may be applied to the rear trunk lid 142 and the front trunk lid 143.

According to an exemplary embodiment of the disclosure, the vehicle user may also control another target vehicle-mounted device 140 related to the opening and closing of the door through the voice, as well as the opening and closing of the door (specifically, the tailgate 141, the rear trunk lid 142, or the front trunk lid 143) through the voice.

When the vehicle user loads a luggage into the door (e.g., the tailgate 141) portion, if a volume of the luggage is too large, the rear seat of the vehicle has to be folded, and the front seat may even be moved or the backrest of the front seat may be tilted to provide space for loading the luggage. Currently, when the vehicle user wants to fold the rear seat, the vehicle user has to go near the door on the rear seat side and fold the rear seat down using a switch or a lever on the rear seat. When the vehicle user wants to move the front seat or recline the backrest of the front seat, the vehicle user has to go near the door on the front seat side and control the front seat. However, since the user may carry the luggage with both hands and may be located near the tailgate 141, it may be inconvenient for the vehicle user to adjust the seat.

In order to solve the above problem, referring back to FIG. 6, the voice information may include the voice information for controlling the seat 146. For example, the voice information may include “fold the rear seat,” “unfold the rear seat,” “move the front seat forward,” “move the front seat backward,” or “tilt the front seat”. Correspondingly, the control unit 160 may include an integrated memory system (IMS) unit 164 for controlling the seat 146.

Currently, a time of a welcome mode and an escort mode of the vehicle is fixed to, for example, 10 s, 20 s, or 30 s. Specifically, when the communication device 110 detects that the vehicle user has entered the detection range, the vehicle controller may control a lamp driving device to turn on a welcome lamp for a predetermined time to welcome the vehicle user before the vehicle user gets into the vehicle. When the vehicle is stopped and the vehicle user gets off the vehicle, the vehicle controller may control the lamp driving device to turn on an escort lamp for a predetermined time. The welcome lamp or the escort lamp may be a headlamp, a back lamp, an interior lamp, an exterior lamp of the door close to the vehicle user, etc. Therefore, when the vehicle user carries the luggage in the vehicle or near the vehicle in a dark place (e.g., an underground parking lot), the vehicle user has to open the driver's side door and adjust a power ON stage of the vehicle to IGN2. IGN2 refers to a state in which power is supplied to each auxiliary device required for vehicle operation. For example, IGN2 corresponds to a state in which power is supplied to a wiper, an air conditioner, a sunroof, the lamp, etc. Therefore, when the power ON stage of the vehicle is IGN2, the vehicle user may obtain lighting. Therefore, when the vehicle user carries the luggage in the vehicle or near the vehicle in the dark place (e.g., the underground parking lot), it may be inconvenient for the vehicle user to turn on the lighting.

To solve the above problem, referring back to FIG. 6, the voice information may include the voice information for controlling a headlamp 147 or a back lamp 148. For example, the voice information may include “turn on the headlamp,” “turn off the headlamp,” “turn on the back lamp,” “turn off the back lamp,” etc. Correspondingly, the control unit 160 may include the ILCU 165 for controlling ON/OFF of the headlamp 147 or the back lamp 148.

In addition to adjusting the location of the seat 146 and controlling the lamp, the voice information may further include the voice information for controlling a window 149 or a sunroof 172. For example, the voice information may include “pull down the window” or “open the sunroof,” etc. Correspondingly, the control unit 160 may include a safety ECU (Electronic Control Unit, 166) for controlling the opening and the closing of the window 149 or the sunroof 172.

Specifically, in the specific implementation shown in FIG. 6, the AVNT 131 and the microphone 121, the speaker 151, or the CCU 132 communicate with each other via the CAN. The BDC 113 and the safety ECU 166 communicate with each other via a local interconnect network (LIN). In addition, the BDC 113 and the CCU 132, the PTL controller 162, the PTG controller 161, the SBCM 163, the ILCU 165, or the IMS unit 164 communicate with each other via the CAN.

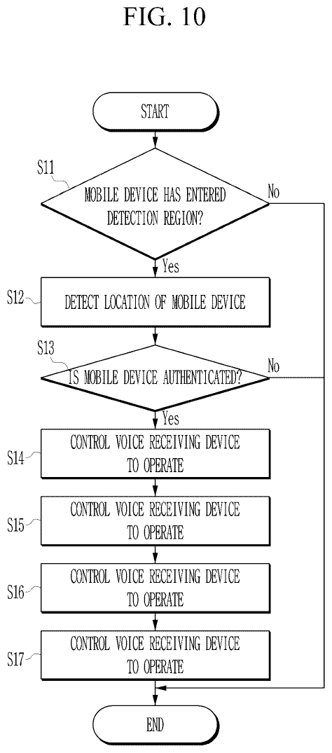

An exemplary embodiment of the disclosure further provides a voice control method for the vehicle. FIG. 10 is a flowchart of the voice control method for the vehicle according to an exemplary embodiment of the disclosure. As illustrated in FIG. 10, the voice control method for the vehicle includes operation S11 of detecting whether the mobile device 200 carried by the vehicle user has entered the detection range of the communication device 110. In response to the mobile device 200 entering the detection range of the communication device 110 (“Yes” in the operation S11), the communication device 110 communicates with the detected mobile device 200 to detect the location of the mobile device 200 in operation S12 and determines whether the mobile device 200 is authenticated by the communication device 110 in operation S13.

In response to determining that the mobile device 200 that has entered the detection range of the communication device 110 is authenticated (“Yes” in the operation S13), the voice control device 130 controls the voice receiving device 120 to operate in operation S14. The voice receiving device 120 receives the voice information outside the vehicle in operation S15. The voice information includes at least voice information for controlling the door and the door includes the tailgate 141, the rear trunk lid 142, or the front trunk lid 143.

The voice information received from the voice receiving device 120 is recognized by the voice control device 130 in operation S16, and the target vehicle-mounted device 140 including the corresponding door is controlled according to the recognized result in operation S17.

Specifically, in the operation in which the communication device 110 detects the location of the mobile device 200, the request signal is transmitted by the plurality of UWB sub-devices 111 or the plurality of BLE sub-devices installed at the plurality of locations of the vehicle, and the request signal forms the detection region outside the vehicle. When the mobile device 200 enters the detection region, an operation of receiving the response signal transmitted by the mobile device 200 in response to the request signal by the communication device 110 is included. The UWB BLE master device 112 detects the location of the mobile device 200 based on the response signal of the mobile device 200 and the request signal of the UWB sub-device 111 or the BLE sub-device.

The operation of detecting whether the mobile device 200 is authenticated by the communication device 110 includes an operation of comparing the verification information of the mobile device 200 included in the response signal of the mobile device 200 with the pre-stored verification information by the UWB BLE master device 112, and detecting that the mobile device 200 is authenticated if the verification information of the mobile device 200 matches one of the pre-stored verification information.

The communication device may further include the BDC, and the UWB BLE master device 112 transmits the detection result (including the location of the mobile device 200 and the authentication of the mobile device 200) to the BDC 113. After receiving the detection result, the BDC 113 may send the wake-up command to the voice control device 130. Specifically, the voice control device 130 may be implemented through the AVNT 131. After the AVNT 131 receives the wake-up command, the AVNT 131 controls the voice receiving device 120 (specifically, the microphone 121) to operate.

The operation of controlling the door by the voice control device 130 includes receiving, by the voice control device 130, the location of the mobile device 200 from the communication device 110 and adjusting, by the voice control device 130, the height at which the door is opened according to the height of the mobile device when the voice control device 130 controls the door opening according to the recognized result.

The operation of controlling the door by the voice control device 130 includes an operation of receiving, by the voice control device 130, the verification information of the mobile device 200 from the communication device 110 and an operation of opening, by the voice control device 130, the door to the height matching the verification information of the mobile device 200 when the voice control device 130 controls the door opening according to the recognized result.

The operation of opening the door to the height matching the verification information of the mobile device 200 by the voice control device 130 includes an operation of obtaining, by the input device 180, the correspondence relationship previously set by the user between the verification information of the mobile device 200 and the door opening height and an operation of opening, by the voice control device 130, the door to the height matching the verification information of the mobile device 200 based on the correspondence relationship received from the input device 180 between the verification information of the mobile device 200 and the door opening height.

In addition to including the voice information for controlling the door, the voice information may further include the voice information for controlling the seat 146, the headlamp 147, the back lamp 148, the window 149, or the sunroof 172. Correspondingly, the target vehicle-mounted device 140 includes the seat 146, the headlamp 147, the back lamp 148, the window 149, or the sunroof 172.

The voice control method for the vehicle further includes an operation of controlling the voice output device 150 to output the control result of the target vehicle-mounted device 140 to the vehicle user by the voice control device 130.

The voice control system and the control method according to exemplary embodiments of the disclosure may open the tailgate 141, the rear trunk lid 142, or the front trunk lid 143 by saying “open the tailgate”, “open the rear trunk lid”, or “open the front trunk lid” when the vehicle user carrying the mobile device 200 approaches the vehicle. Accordingly, the inconvenience that the door is automatically opened when the vehicle user approaches the door even without intending to open the door or the inconvenience of operating the door with the kicking motion may be prevented.

In addition, the human-computer interaction may be added through the voice control form, thereby increasing the intelligence of the vehicle.

According to the voice control system and the control method according to exemplary embodiments of the disclosure, the opening height of the tailgate 141, the rear trunk lid 142, or the front trunk lid 143 may be automatically adjusted according to the height of the vehicle user, so that the vehicle user may use the tailgate 141, the rear trunk lid 142, or the front trunk lid 143 conveniently.

In addition to controlling the tailgate 141, the rear trunk lid 142, or the front trunk lid 143 through the voice, the driver may also control the seat 146, the headlamp 147, and/or the back lamp 148, etc. through the voice.

The various exemplary embodiments of the disclosure do not enumerate all possible combinations, but rather illustrate representative aspects of the disclosure, and furthermore, the contents described in the various exemplary embodiments may be applied independently or in combinations of two or more.

The description of the above exemplary implementation method is only for describing the technical measures of the disclosure, should not be considered complete, nor does it intend to limit the disclosure to the exact form described. Of course, it is obvious that a person skilled in the art may proceed with various modifications and changes depending on the descriptions above. The selection of an exemplary implementation method is to be interpreted by a specific principle of the disclosure and an actual application of the disclosure, so that a person skilled in the art may use each exemplary embodiment of the disclosure and other alternative forms and modifications thereof. The scope of the disclosure is limited by the attached claims and the equivalent form thereof.

What is claimed is:

1. A voice control system for a vehicle, the voice control system comprising:
a communication device configured to detect a location of a mobile device of a vehicle user by communicating with the detected mobile device and to detect whether the mobile device is authenticated;
a voice receiving device configured to receive voice information of the vehicle user; and
a voice control device configured to:
receive the voice information from an outside of the vehicle when the authenticated mobile device has entered a detection range of the communication device, and
recognize the voice information received from the voice receiving device; and
control a target vehicle-mounted device according to the recognized voice information.

2. The voice control system of claim 1, wherein:
the voice information includes voice information for controlling the target vehicle-mounted device including at least a door of the vehicle.

3. The voice control system of claim 2, wherein:
the communication device includes a plurality of ultra-wideband (UWB) sub-devices or a plurality of Bluetooth low energy (BLE) sub-devices and a UWB BLE master device,
the plurality of UWB sub-devices or the plurality of BLE sub-devices is provided at a plurality of locations of the vehicle,
the plurality of UWB sub-devices or the plurality of BLE sub-devices, each is configured to transmit a request signal, wherein the request signal forms a detection region outside the vehicle, and is configured to receive a response signal transmitted in response to the request signal when the mobile device enters the detection region, and
the UWB BLE master device is configured to detect the location of the mobile device based on the response signal from the mobile device and the request signal from at least one of the plurality of UWB sub-devices or the plurality of BLE sub-devices.

4. The voice control system of claim 3, wherein the UWB BLE master device is further configured to:
compare verification information of the mobile device included in the response signal from the mobile device with pre-stored verification information and
detect that the mobile device is authenticated when the verification information of the mobile device matches one of the pre-stored verification information.

5. The voice control system of claim 3, wherein the voice control device is further configured to:
receive the location of the mobile device from the communication device and
adjust a door opening height according to a height of the mobile device.

6. The voice control system of claim 4, wherein the voice control device is configured to:
receive the verification information of the mobile device from the communication device and
open the door to a height matching the verification information of the mobile device.

7. The voice control system of claim 6, further comprising:
an input device configured to obtain a correspondence relationship between the verification information of the mobile device and a door opening height preset by the vehicle user,
wherein the voice control device is further configured to open the door to the height matching the verification information of the mobile device based on the correspondence relationship between the verification information of the mobile device received from the input device and the door opening height.

8. The voice control system of claim 7, wherein:
the door opening height is within a range of 30 cm to 160 cm.

9. The voice control system of claim 2, wherein:
the voice information includes voice information for controlling a seat, a headlamp, a back lamp, a window, or a sunroof, and
the target vehicle-mounted device includes the seat, the headlamp, the back lamp, the window, or the sunroof.

10. The voice control system of claim 1, further comprising:
a voice output device,
wherein the voice control device is configured to control the voice output device to output a control result of the target vehicle-mounted device to the vehicle user.

11. The voice control system of claim 10, wherein:
the voice receiving device is a microphone, and
the microphone is provided on each of outside rearview mirrors on left and right sides of the vehicle, the tailgate or the rear trunk lid, or inside the mobile device.

12. A vehicle comprising the voice control system of claim 1.

13. A voice control method for a vehicle, the control method comprising:
detecting, by a communication device, whether a mobile device of a vehicle user has entered a detection range of the communication device;
detecting, by the communication device, a location of the mobile device when the mobile device of the vehicle user has entered the detection range of the communication device;
detecting, by the communication device, whether the mobile device is authenticated;
operating, by a voice control device, a voice receiving device in response to detecting that the authenticated mobile device has entered the detection range of the communication device;
receiving, by the voice receiving device, voice information of the vehicle user;
recognizing, by the voice control device, the voice information received from the voice receiving device; and
controlling, by the voice control device, a target vehicle-mounted device according to the recognized voice information.

14. The voice control method of claim 13, wherein:
the voice information includes voice information for controlling the target vehicle-mounted device including at least a door.

15. The voice control method of claim 14, wherein detecting the location of the mobile device includes:
transmitting a request signal by at least one of a plurality of ultra-wideband (UWB) sub-devices or a plurality of Bluetooth low energy (BLE) sub-devices installed at a plurality of locations of the vehicle, wherein the request signal forms a detection region outside the vehicle;
receiving a response signal transmitted from the mobile device in response to the request signal by the at least one of the plurality of UWB sub-devices or the plurality of BLE sub-devices when the mobile device enters the detection region; and
detecting the location of the mobile device based on the response signal from the mobile device and the request signal from the at least one of the plurality of UWB sub-devices or the plurality of BLE sub-devices by a UWB BLE master device.

16. The voice control method of claim 15, wherein detecting whether the mobile device is authenticated includes:
comparing verification information of the mobile device included in the response signal of the mobile device with pre-stored verification information by the UWB BLE master device; and
detecting that the mobile device is authenticated by the UWB BLE master device when the verification information of the mobile device matches one of the pre-stored verification information.

17. The voice control method of claim 15, wherein controlling the door includes:
receiving, by the voice control device, the location of the mobile device from the communication device; and
adjusting, by the voice control device, a door opening height according to a height of the mobile device.

18. The voice control method of claim 15, wherein controlling the door includes:
receiving, by the voice control device, the verification information of the mobile device from the communication device; and
opening, by the voice control device, the door to a height matching the verification information of the mobile device.

19. The voice control method of claim 18, wherein opening the door to the height matching the verification information of the mobile device includes:
obtaining, by an input device, a correspondence relationship between the verification information of the mobile device and a door opening height previously set by the vehicle user; and
opening, by the voice control device, the door to the height matching the verification information of the mobile device based on the correspondence relationship between the verification information of the mobile device received from the input device and the door opening height.

20. The voice control method of claim 13, further comprising:
controlling, by the voice control device, a voice output device to output a control result of the target vehicle-mounted device to the vehicle user.
